(19) United States
(12) Patent Application Publication
(10) Pub. No.: US 2004/0138470 A1
(43) Pub. Date: Jul. 15, 2004

(54) Chiral diphosphines and their metal complexes

(76) Inventors: Jean-Pierre Genet, Verrieres-le-Buisson (FR); Angela Marinetti, Chatenay-Malabry (FR); Guillaume Michaud, Paris (FR); Michel Bulliard, Angers (FR)

Correspondence Address: IP DEPARTMENT OF PIPER RUDNICK LLP, 3400 TWO LOGAN SQUARE, 18TH AND ARCH STREETS, PHILADELPHIA, PA, 19103, US

(21) Appl. No.: 10/432,685

(22) PCT Filed: Nov. 16, 2001
(86) PCT No.: PCT/FR01/03607

(30) Foreign Application Priority Data
Nov. 17, 2000 (FR) 00/14895

(51) Int. Cl. C07F 9/02

(52) U.S. Cl. 548/123; 568/10

(57) ABSTRACT

Novel chiral diphosphines (R) or (S), and their use as optically active ligand for preparing diphosphino-metallic complexes, and the diphosphino-metallic complexes containing said chiral diphosphines (R) or (S), and the use of the diphosphino-metallic complexes as catalyst in asymmetric catalysis of unsaturated compounds bearing functional groups.

### RELATED APPLICATION

This application is a §371 of International Patent Application No. PCT/FR01/03607, filed Nov. 16, 2001, published as WO 02/40492 A1 on May 23, 2002, which claims priority of French Patent Application No. 00/14895, filed Nov. 17, 2000.

### FIELD OF THE INVENTION

This invention relates to dissymmetric atropisomer diphosphines, their synthesis and their use as optically active ligands for the preparation of diphosphino-metal complexes. The invention also pertains to diphosphino-metal complexes comprising a dissymmetric chiral diphosphine ligand and the asymmetric catalysis processes employing these complexes. The invention envisages more particularly the use of these diphosphino-metal complexes in asymmetric hydrogenation or hydrogen-transfer procedures for the synthesis of organic products of specified chirality.

### BACKGROUND

FUPMOP is known in the prior art. It is a dissymmetric atropisomer used for the synthesis of diphosphino-metal complexes having enantioselective catalytic properties in hydrogenation (M. Murata et al., Synlett, 1991, page 827).

### SUMMARY OF THE INVENTION

This invention relates to novel chiral diphosphines (R) or (S), and their use as optically active ligand for preparing diphosphino-metallic complexes.

This invention also relates to the diphosphino-metallic complexes containing said chiral diphosphines (R) or (S), and the use of the diphosphino-metallic complexes as catalyst in asymmetric catalysis of unsaturated compounds bearing functional groups.

### BRIEF DESCRIPTION OF THE DRAWINGS

FIG. 1 is a reaction diagram showing the progression from formula (XIII) to formula (XII) to formula (I).

FIG. 2 is a reaction diagram showing the transformation from formula (XV) to formula (XIV) to formula (XIII).

FIG. 3 is a reaction diagram of the transformation from formula (XVIII A) to formula (XVI) and the reaction of formulae (XVII) and (XVI) to formula (XV).

FIG. 4 is a reaction diagram showing the transformation of formula (XIX A) to formula (XVIII A) to formula (XVI) and the transformation of formula (XIX B) to formula (XVM B) to formula (XVII).

FIG. 5 is a table of selected compounds taken from the Examples and selected reaction conditions.

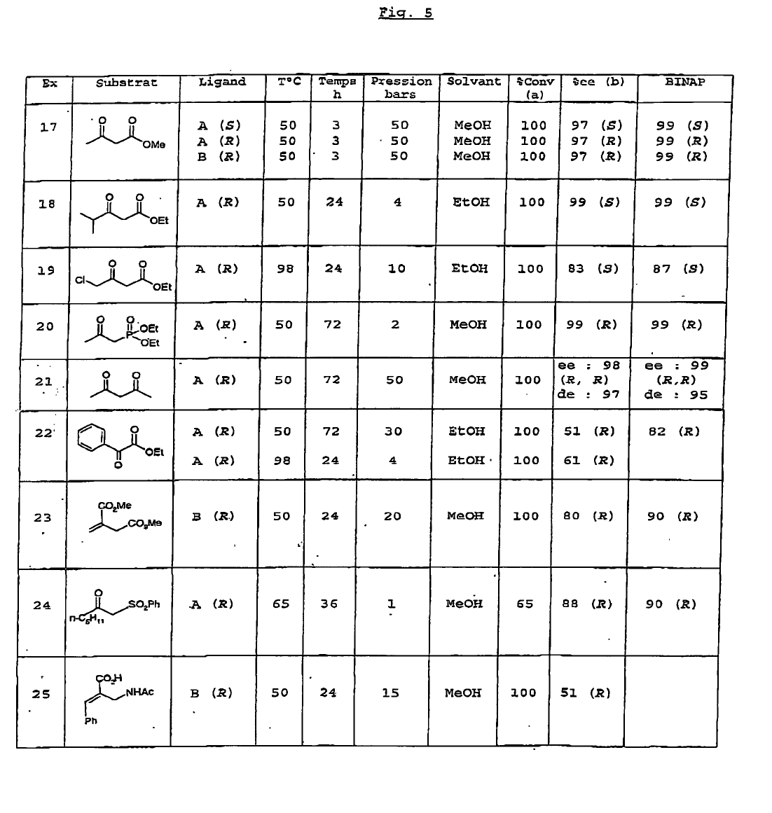

### DETAILED DESCRIPTION

We have now developed new diphosphino-metal complexes comprising a dissymmetric atropisomer diphosphine as optically active ligand which are particularly useful for the synthesis of organic products of specified chirality with very high yields and enantioselectivity.

Please replace the paragraph spanning pages 1 and 2 with the following:

Thus, the invention [has as its object the use of] includes an (R) or (S) chiral diphosphine of formula (1):

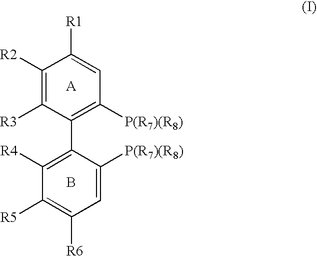

wherein R₁, R₂, R₃, R₄, R₅ and R6, which can be [identical] the same or different, are selected from among a hydrogen atom, a halogen such as chlorine, bromine or fluorine, an optionally saturated C₁₋₄ alkyl group, an optionally saturated C₁₋₄ alkoxy group, a C₄₋₆ aryloxy group, [said] the alkyl, alkoxy or aryloxy groups being optionally substituted by a halogen, a hydroxy, a C₁₋₅ alkyl or a benzyl,

or R₂ and R₃ or R₄ and R₅ together form an optionally substituted benzene ring, a methylene dioxy group, ethylene dioxy group, optionally saturated C₃₋₇ cycloalkyl group, such as an optionally substituted cyclohexyl, or a heterocycle of formula (II):

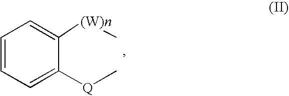

[in which] wherein W and Q, which can be [identical] the same or different, are selected from among an oxygen atom, a sulfoxide (—SO) or a sulfone (—SO₂) functional group or a methylene group and n is equal to 0 or 1,

or R₃ and R₄ form a ring such as a C₂₋₄ alkylene dioxy such as a methylene dioxy, an ethylene dioxy, an optionally saturated C₃₋₇ cycloalkyl, such as an optionally substituted cycloalkyl, a heterocycle of formula (II) optionally substituted by a halogen, a hydroxy, a C₁₋₅ alkyl or a C₁₋₅ alkoxy;

R₇ and R₈, which can be [identical] the same or different, represent an aryl optionally substituted by an alkyl, a halogen or an alkoxy such as, for example, a phenyl, a tolyl, a trimethyl phenyl or a tertiobutyl phenyl, or represents a C₅₋₆ cycloalkyl such as, for example, a cyclopentyl, a cyclohexyl optionally substituted by an alkyl, a halogen or an alkoxy.

On page 2, please replace the second full paragraph with the following:

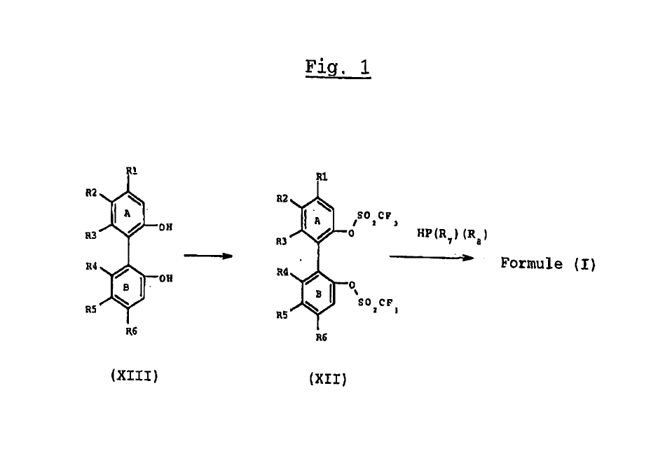

The (R) or (S) chiral diphosphines of formula (1) of the [present] invention are prepared by a procedure of the type described by D. CAI et al. (J. Org. Chem. 1994, p. 7180) from compounds of formula (XIII), then formula (XII) according to the reaction diagram [represented] in [figure] FIG. 1 [of the attached drawings].

On page 3, please replace the first two full paragraphs with the following:

These compounds, most particularly the compounds of formula (XII), also comprise part of the [present] invention. The invention consequently pertains to compounds of general formula (XXIV) below:

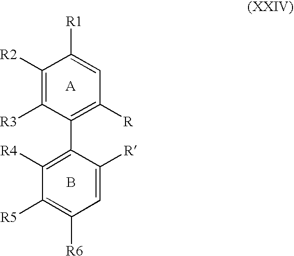

[in which] wherein R₁ to R₆ have the same meanings as in formula (I) above and R and R′, which are [identical] the same, represent either an —OH group or a group of formula —P(R₇)(R₈) in which R₇ and R₈ have the same meanings as in formula (I).

The following can be cited as dissymmetric chiral diphosphines of formula (I):

6-methoxy-5′,6′-benzo-2,2′-bis(diphenylphosphino) biphenyl (S).

4,5,6-trimethyl-5,6′-benzo-2,2′-bis(diphenylphosphino) biphenyl (R).

6-methoxy-5′,6′-methylenedioxo-2,2′-bis9-diphenylphosphino) biphenyl (S), and [-] 6′-methoxy-5,6-methylenedioxo-2,2′-bis(diphenylphosphino) biphenyl (S).

Please replace the paragraph spanning pages 3 and 4 with the following:

A first group of diphosphino-metal complexes prepared using the chiral diphosphines of formula (I) according to the invention corresponds to formula (III) below:

MₓH_{y}X_{z}(L)₂ (Sᵥ)ₚ (III)

[in which:]

wherein [-] M represents a metal such as ruthenium, rhodium or iridium;

X represents a halogen such as chlorine, bromine, fluorine or iodine;

Sᵥ represents a tertiary amine, a ketone or an ether;

L represents an (R) or (S) chiral diphosphine of formula (I) above;

y is a whole number equal to 0 or 1;

x is a whole number equal to 1 or 2;

z is a whole number equal to 1, 2 or 4; and

p is a whole number equal to 0 or 1.

On page 4, please replace the second and third full paragraphs with the following:

The complexes of formula (IIIA) are those of formula (III) in which y=0 and then x=2, z=4 and p=1, corresponding to the following formula:

M₂X₄L₂ (Sv) (IIIA)

[in which:]

wherein M, X, L and Sv have the same meanings as in formula (III).

The compounds of formula (IIIB) are those of formula (m) in which y 1 then x=1, z=1 and p=0, corresponding to the following formula:

MHXL₂ (IIIB)

[in which:]

wherein M, X and L have the same meanings as in formula (III) and H represents a hydrogen atom.

A second group of diphosphino-metal complexes prepared using the chiral diphosphines of formula (1) according to the invention corresponds to the following formula (IV):

MXⱼ(Ar)ₘLYₙ (IV)

[in which:]

wherein [-] M, X and L have the same meanings as in formula (III),

Ar represents an olefin such as ethylene, 1,3-butadiene, cyclohexadiene, norbonadiene, cycloocta-1,5-diene, a pi-allyl, a nitrile such as acetonitrile, an arene of formula (V):

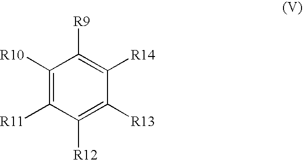

[in which] wherein R₉, R₁₀, R₁, R₁₂, R₁₃ and R₁₄, which can be [identical] the same or different, are selected from among a hydrogen atom, a C₁₋₅ alkyl group, an isoalkyl group, a tertioalkyl group, an alkoxy group, said groups optionally comprising one or more heteroatoms such as O, N and Si,

Y represents an anion such as ClO₄⁻, BF₄⁻ or PF₆⁻ and

j is a whole number equal to 0 or 1, m is a whole number equal to 1, 2 or 4, and n is a whole number equal to 1 or 2.

On page 5, please replace the first and second full paragraphs with the following:

A third group of diphosphino-metal complexes prepared using the chiral diphosphines of formula (I) according to the invention corresponds to the following formula (VI):

[[ ](MX(P(R₁₅)₂(R₁₆))L[ ]])₂X (VI)

[in which:]

wherein M, X and L have the same meanings as in formula (III) and R₁₅ and R₁₆, which can be [identical] the same or different, represent a phenyl or a phenyl substituted by an alkyl, an alkoxy or a dialkylamino.

A fourth group of diphosphino-metal complexes prepared using the chiral diphosphines of formula (I) according to the invention corresponds to formula (VII) below:

M(L)Z₂ (VII)

[in which:]

wherein M and L have the same meanings as in formula (E) and Z represents an acetate group of formula R₁₇COO⁻, diacetate group of formula ⁻OOCR₁₇COO—, an aminoacetate group of formula R₁₇CH(NH₂)COO⁻ in which R₁₇ represents a C₁₋₄ alkyl, a C₁₋₄ halogenoalkyl or an optionally substituted phenyl.

Please replace the paragraph spanning pages 5 and 6 with the following:

A fifth group of diphosphino-metal complexes prepared using the chiral diphosphines of formula (I) according to the invention corresponds to formula (VIII) below:

[[ ](M(L)WXₖ[ ]])ₙZ′ₚ (VIII)

[in which:]

wherein M, L and X have the same meanings as in formula (III);

W represents zinc, aluminum, titanium or tin;

Z represents:

either an acetate group of formula R₁₈COO⁻ in which R₁₈ represents a C₁₋₄ alkyl, a C₁₋₄ halogenoalkyl, an optionally substituted phenyl, and in this case n=1 and p=2, and when W is Zn then k=2, when W is Al then k=3, and when W is Ti or Sn then k=4,

or a tertiary amine such as triethylamine, and in this case n=2 and p=1, and when W is Zn then k=4, when W is Al then k=5 and when W is Ti or Sn then k=6.

On page 6, please replace the first through fourth full paragraphs with the following:

A sixth group of diphosphino-metal complexes prepared using the chiral diphosphines of formula (I) according to the invention corresponds to formula (IX) below:

MH(L)₂Y (IX)

[in which:]

wherein M and L have the same meanings as in formula (III), H represents a hydrogen atom and Y represents an anion such as ClO₄⁻, BF₄⁻ or PF₆⁻.

A seventh group of diphosphino-metal complexes prepared using the chiral diphosphines of formula (I) according to the invention corresponds to formula (X) below:

M(L)Y₂ (X)

[in which:]

wherein M and L have the same meanings as in formula (III) and Y represents an anion such as ClO₄⁻, BF₄⁻ or PF₆⁻.

An eighth group of diphosphino-metal complexes prepared using the chiral diphosphines of formula (I) according to the invention corresponds to formula (XI) below:

M(L)₂Y (XI)

[in which:]

wherein M and L have the same meanings as in formula (III) and Y represents an anion such as ClO₄⁻BF₄⁻ or PF₆⁻.

As previously stated, the (R) or (S) chiral diphosphines of formula (I) of the present invention are prepared by a method of the type described by D. CAI et al. (J. Org. Chem. 1994, p. 7180) from compounds of formula (XEII) then formula (XH) according to the reaction diagram represented in [figure] FIG. 1 [of the attached drawings].

On page 7, please replace the fourth and fifth paragraphs with the following:

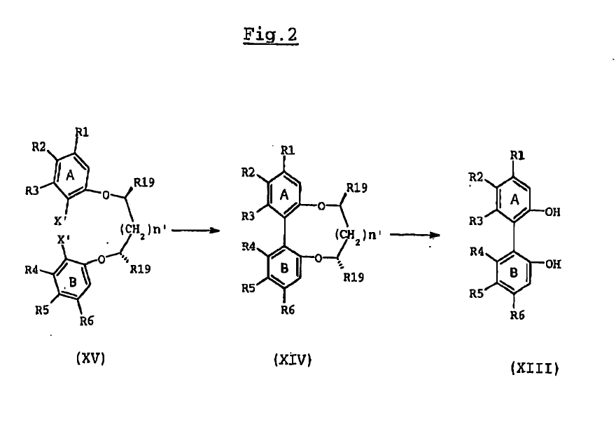

The compound of formula (XI) is prepared from compounds of formula (XV) and (XIV) according to the reaction diagram shown in [figure] FIG. 2 [of the attached drawings].

In the reaction diagram represented in [figure] FIG. 2, a coupling reaction is implemented of the compound of formula (XV) below:

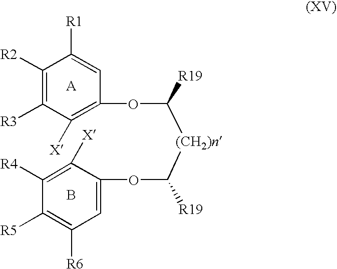

according to the method developed by B. H. Lipschutz, so as to form the diastereoisomerically pure compound of formula (XIV) below:

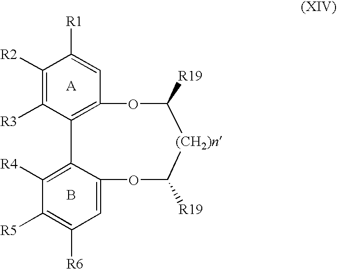

The compound of formula (XV) is obtained by a Mitsunobu reaction between the compounds of formula (XVI) and (XVII) below:

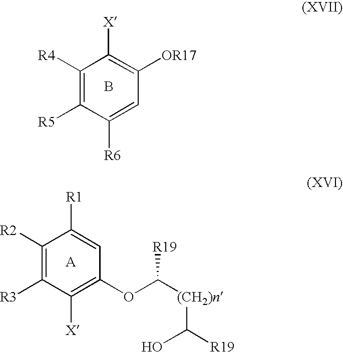

[in which] wherein R₁ to R₆, R₁₉ and X′ have the same meanings as in formulas (XV) and (XIV), and R₁₇ represents an alkyl aryl or arylalkyl group such as methyl, ethyl, phenyl or benzyl.

On page 8, please replace the third paragraph with the following:

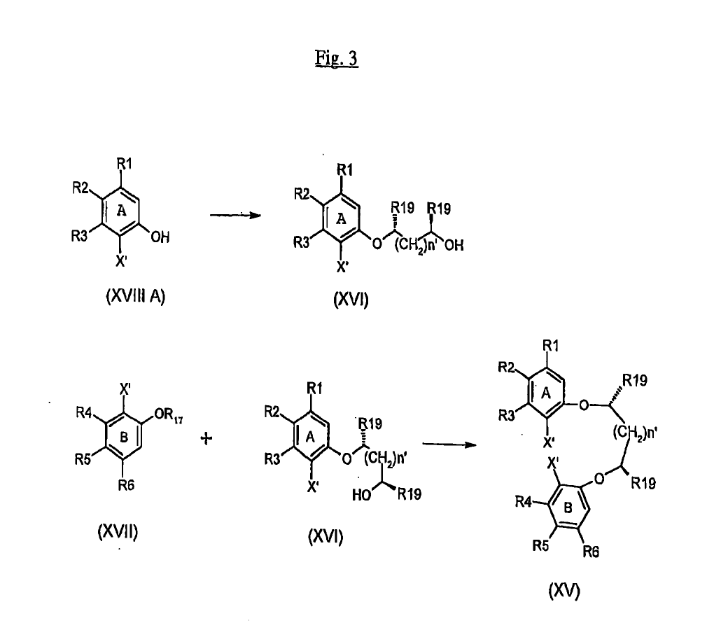

These two successive Mitsunobu reactions are represented in the reaction diagram shown in [figure] FIG. 3 [of the attached drawings].

On page 8, please replace the fifth paragraph with the following:

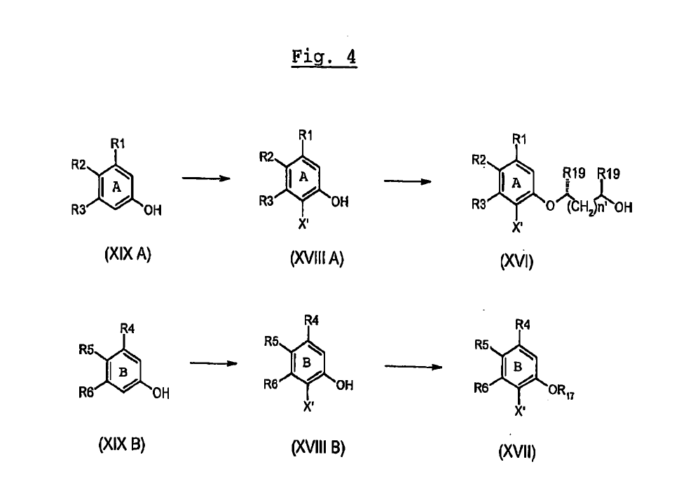

Thus, the compounds of formulas (XVI) and (XVII) are obtained respectively from 2-halo-genophenolic compounds of formulas (XVIIIA) and (XVIIIB) which are themselves obtained respectively from phenolic compounds of formulas (XIXA) and (XIXB) below according to the reaction diagram shown in [figure] FIG. 4 [of the attached drawings]:

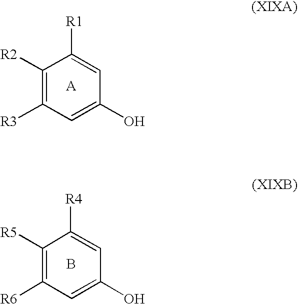

According to the process described in the European patent application published as no. 184 057, the complexes of formula (III) can be prepared from a compound of formula (XX):

MX₂(COD)₂ (XX)

[in which] wherein M and X have the same meanings as in formula (III) and COD represents cyclooctadiene.

Please replace the paragraph spanning pages 8 and 9 with the following:

Similarly, according to the process described in the European patent application published as no. 366 390, the complexes of formula (IV) can be prepared from compounds of formula (XXI):

[[ ](MX₂(Ar0[ ]])₂ (XXI)

[in which] wherein M and X have the meanings as in formula (III).

Finally, according to the process described in the European patent application published as no. 470 756, the compounds of formula (VI) can be prepared from compounds of formula (XXII):

[[ ](MX(P(R₁₅)₂(R₁₆))(DMA)[ ]]hX (XXII)

[in which:]

wherein M, X, R₁₅ and R₁₆ have the same meanings as in formula (VI) and DMA represents dimethylacetamide.

The present invention also pertains to the diphosphino-metal complexes of formulas (III), (IV), (VI), (VII), (VIII), (IX), (X) and (XI) as well as their use as catalyst in asymmetric catalysis procedures and more particularly their use in asymmetric hydrogenation or hydrogen transfer procedures of unsaturated compounds bearing functional groups of formula (XXI) below:

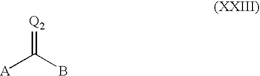

wherein A and B are different and selected from among a C₁₋₅ alkyl group, an aryl group, a C₁₋₇ hydroxycarbonyl group, a C₁₋₇ alkoxycarbonyl group, a C₁₋₁₀ aryloxycarbonyl group, a C₁₋₇ halogenoalkyl group, a heteroaryl group, an optionally saturated cycloalkyl group, said alkyl, aryl and cycloalkyl groups optionally comprising one or more subsuituents selected from among a halogen such as chlorine, fluorine or bromine, a NO₂ group, a C₁₋₅ alkyl group, a C₁₋₅ alkoxy group, an optionally fused C₁₋₇ cycloalkyl group, an optionally fused aryl group possibly substituted by a halogen, a C₁₋₅ alkyl, a C₁₋₅ alkoxy, [said] the alkyl, cycloalkyl, aryl groups optionally comprising one or more heteroatoms such as O, N or Si,

or A and B together form a C₂₋₆ substituted alkyl group, an optionally saturated C₃₋₉ cycloalkyl group, a C₅₋₁₀aryl group, [said] the groups being optionally substituted by a C₁₋₅ alkyl, a halogen, a hydroxy, a C₅₋₁₀ alkoxy, [said] the groups being optionally substituted by a C₁₋₅ alkyl, a halogen, a hydroxy, a C₁₋₅ alkoxy, an amino such as —NH₂, —NHR₂₀, —N(R₂₀)₂, a sulfino, a sulfonyl, in which R₂₀ represents an alkyl, an alkoxy or an alkylcarbonyl, [said] the alkyl, cycloalkyl and aryl groups optionally comprising one or more heteroatoms such as O, N, S or Si;

Q₁ represents an oxygen, a —NR₂₁, —NOR₂₁ or —C(R₂₂)₂ group in which R₂₁ is selected from among a C₁₋₅ alkyl an aryl group or a heteroaryl group substituted by a C₁₋₄ alkyl.

On page 10, please replace the second full paragraph with the following:

A preferred asymmetric hydrogenation procedure according to the invention comprises the treatment of a compound of formula (XXIII) in a suitable solvent in the presence of a catalytic complex of formula (III), (IV), (VI), (VII), (VII), (IX), (X) or (XI) as catalyst under the following preferred operating conditions:

a temperature comprised between 0 and +150° C.,

a hydrogen pressure between 1 and 100 bar,

an amount of catalyst in relation to the amount of substrate comprised between 1/50,000 and 1/10, preferably between 1/10,000 and 1/10, and especially preferably between 1/10,000 and 1/1000.

claims 1-28 (cancelled)

29. (New) a compound of formula (XXIV) below: 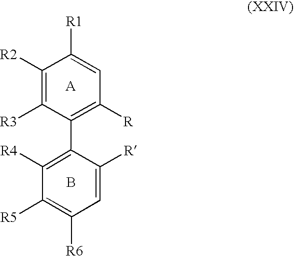
wherein R₁, R₂, R₃, R₄, R₅ and R₆, which can be the same or different, represent a hydrogen atom, a halogen, an optionally saturated C₁₋₄ alkyl group, an optionally saturated C₁₋₄ alkoxy group, a C₄₋₆ aryloxy group, the alkyl, alkoxy or aryloxy groups being optionally substituted by a halogen, a hydroxy, a C₁₋₅ alkyl or a benzyl,
or R₂ and R₃ or R₄ and R₅ together form an optionally substituted benzene ring, a methylene dioxy group, ethylene dioxy group, optionally saturated C₃₋₇ cycloalkyl group, such as an optionally substituted cyclohexyl, or a heterocycle of formula (II): 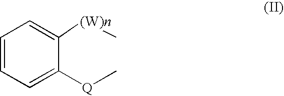
wherein W and Q, which can be the same or different, represent an oxygen atom, a sulfoxide (—SO) or a sulfone (—SO₂) functional group or a methylene group and n is equal to 0 or 1,
or R₃ and R₄ form a ring from a C₂₋₄ alkylene dioxy, an ethylene dioxy, an optionally saturated C₃₋₇ cycloalkyl, a heterocycle of formula (II) optionally substituted by a halogen, a hydroxy, a C₁₋₅ alkyl or a C₁₋₅ alkoxy;
R and R′, which are the same, represent either an H group or a group of formula —P(R₇)(R₈), wherein R₇ and R₈, which can be the same or different, represent an aryl optionally substituted by an alkyl, a halogen or an alkoxy, or represents a C₅₋₆ cycloalkyl.

30. (New) An (R) or (S) chiral diphosphine of formula (I): 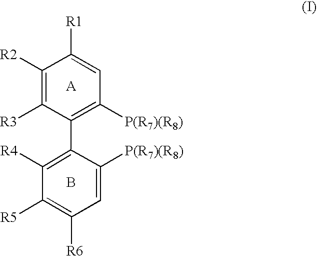
wherein R₁, R₂, R₃, R₄, R₅ and R₆, which can be the same or different, represent a hydrogen atom, a halogen, an optionally saturated C₁₋₄ alkyl group, an optionally saturated C₁₋₄ alkoxy group, a C₄₋₆ aryloxy group, the alkyl, alkoxy or aryloxy groups being optionally substituted by a halogen, a hydroxy, a C₁₋₅ alkyl or a benzyl,
or R₂ and R₃ or R₄ and R₅ together form an optionally substituted benzene ring, a methylene dioxy group, ethylene dioxy group, optionally saturated C₃₋₇ cycloalkyl group, such as an optionally substituted cyclohexyl, or a heterocycle of formula (11): 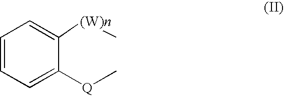
wherein W and Q, which can be the same or different, represent an oxygen atom, a sulfoxide (—SO) or a sulfone (—SO₂) functional group or a methylene group and n is equal to 0 or 1,
or R₃ and R₄ form a ring from a C₂₋₄ alkylene dioxy, an ethylene dioxy, an optionally saturated C₃₋₇ cycloalkyl, a heterocycle of formula (II) optionally substituted by a halogen, a hydroxy, a C₁₋₅ alkyl or a C₁₋₅ alkoxy;
wherein R₇ and R₈, which can be the same or different, represent an aryl optionally substituted by an alkyl, a halogen, an alkoxy or a C₅₋₆ cycloalkyl.

31. (New) A compound of formula (XIII) below: 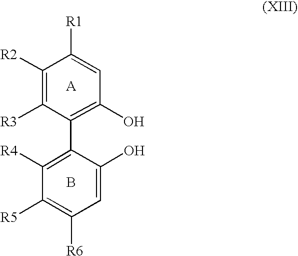
wherein R₁, R₂, R₃, R₄, R₅ and R₆, which can be the same or different, represent a hydrogen atom, a halogen, an optionally saturated C₁₋₄ alkyl group, an optionally saturated C₁₋₄ alkoxy group, a C₄₋₆ aryloxy group, the alkyl, alkoxy or aryloxy groups being optionally substituted by a halogen, a hydroxy, a C₁₋₅ alkyl or a benzyl,
or R₂ and R₃ or R₄ and R₅ together form an optionally substituted benzene ring, a methylene dioxy group, ethylene dioxy group, optionally saturated C₃₋₇ cycloalkyl group, such as an optionally substituted cyclohexyl, or a heterocycle of formula (II): 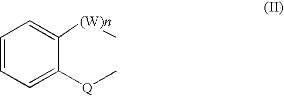
wherein W and Q, which can be the same or different, represent an oxygen atom, a sulfoxide (—SO) or a sulfone (—SO₂) functional group or a methylene group and n is equal to 0 or 1,
or R₃ and R₄ form a ring from a C₂₋₄ alkylene dioxy, an ethylene dioxy, an optionally saturated C₃₋₇ cycloalkyl, a heterocycle of formula (11) optionally substituted by a halogen, a hydroxy, a C₁₋₅ alkyl or a C₁₋₅ alkoxy.

32. (New) An (R) or (S) chiral diphosphine of formula (I) according to claim 30, selected from the group consisting of:
6-methoxy-5′,6′-benzo-2,2′-bis(diphenylphosphino) biphenyl (S),
4,5,6-trimethyl-5,6′-benzo-2,2′-bis(diphenylphosphino) biphenyl (R),
6-methoxy-5′,6′-methylenedioxo-2,2′-bis(diphenylphosphino) biphenyl (S) and
6′-methoxy-5,6-methylenedioxo-2,2′-bis(diphenylphosphino) biphenyl (S).

33. (New) A diphosphino-metal complex comprising an (R) or (S) chiral diphosphine according to claim 30, corresponding to formula (III):
MₓH_{y}X_{z}(L)₂ (Sv)ₚ (III)
wherein M represents ruthenium, rhodium or iridium;
H represents a hydrogen atom;
X represents chlorine, bromine, fluorine or iodine;
Sᵥ represents a tertiary amine, a ketone or an ether;
L represents an (R) or (S) chiral diphosphine of formula (I);
y is a whole number equal to 0 or 1;
x is a whole number equal to 1 or 2;
z is a whole number equal to 1, 2 or 4; and
p is a whole number equal to 0 or 1.

34. (New) A diphosphino-metal complex according to claim 30, corresponding to formula (IIIA) below:
M₂X₄L₂ (Sv) (IIIA)
wherein M represents ruthenium, rhodium or iridium;
X represents chlorine, bromine, fluorine or iodine;
Sᵥ represents a tertiary amine, a ketone or an ether; and
L represents an (R) or (S) chiral diphosphine of formula (I).

35. (New) A diphosphino-metal complex according to claim 30, corresponding to formula (III) below:
MHXL₂ (IIIB)
wherein M represents ruthenium, rhodium or iridium;
X represents chlorine, bromine, fluorine or iodine;
L represents an (R) or (S) chiral diphosphine of formula (I); and
H represents a hydrogen atom.

36. (New) A diphosphino-metal complex comprising an (R) or (S) chiral diphosphine according to claim 30, corresponding to formula (IV) below:
MXⱼ(Ar)ₘLYₙ (IV)
wherein M represents ruthenium, rhodium or iridium;
X represents chlorine, bromine, fluorine or iodine;
L represents an (R) or (S) chiral diphosphine of formula (I);
Ar represents an olefin such as ethylene, 1,3-butadiene, cyclohexadiene, norbonadiene, cycloocta-1,5-diene, a pi-allyl, a nitrile such as acetonitrile, an arene of formula (V): 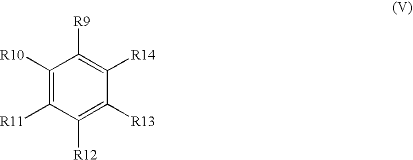
wherein R₉, R₁₀, R₁₁, R₁₂, R₁₃ and R₁₄, which can be the same or different, are selected from the group consisting of a hydrogen atom, a C₁₋₅ alkyl group, an isoalkyl group, a tertioalkyl group, and an alkoxy group, the groups optionally comprising one or more of O, N and Si, Y represents an anion such as ClO₄⁻, BF₄⁻ or PF₆⁻, and
j is a whole number equal to 0 or 1, m is a whole number equal to 1, 2 or 4, and n is a whole number equal to 1 or 2.

37. (New) A diphosphino-metal complex comprising an (R) or (S) chiral diphosphine according to claim 30, corresponding to formula (VI) below:
(MX(P(R₁₅)₂(R₁₆))L)₂X (VI)
wherein M represents ruthenium, rhodium or iridium;
X represents chlorine, bromine, fluorine or iodine;
P represents phosphorous;
L represents an (R) or (S) chiral diphosphine of formula (I); and
R₁₅ and R₁₆, which can be the same or different, represent a phenyl or a phenyl substituted by an alkyl, an alkoxy or a dialkylamino.

38. (New) A diphosphino-metal complex comprising an (R) or (S) chiral diphosphine according to claim 30, corresponding to formula (VII) below:
M(L)Z₂ (VII)
wherein M represents ruthenium, rhodium or iridium;
L represents an (R) or (S) chiral diphosphine of formula (I); and
Z represents an acetate group of formula R₁₇COO⁻, diacetate group of formula ⁻OOCR₁₇COO⁻, an aminoacetate group of formula R₁₇CH(NH₂)COO⁻ in which R₁₇ represents a C₁₋₄ alkyl, a C₁₋₄ halogenoalkyl or an optionally substituted phenyl.

39. (New) A diphosphino-metal complex comprising an (R) or (S) chiral diphosphine according to claim 30, corresponding to formula (VIII) below:
(M(L)WXₖ)ₙZ′ₚ (VIII)
wherein M represents ruthenium, rhodium or iridium;
L represents an (R) or (S) chiral diphosphine of formula (I);
X represents chlorine, bromine, fluorine or iodine;
W represents zinc, aluminum, titanium or tin; and
Z represents:
either an acetate group of formula R₁₈COO⁻ wherein R₁₈ represents a C₁₋₄ alkyl, a C₁₋₄ halogenoalkyl, an optionally substituted phenyl, n=1 and p=2, with the proviso that when W is Zn, then k=2, when W is Al, then k=3, and when W is Ti or Sn, then k=4,
or a tertiary amine such as triethylamine, n=2 and p=1, with the proviso that when W is Zn, then k=4, when W is Al, then k=5 and when W is Ti or Sn, then k=6.

40. (New) A diphosphino-metal complex comprising an (R) or (S) chiral diphosphine according to claim 30, corresponding to formula (IX):
MH(L)₂Y (IX)
wherein M represents ruthenium, rhodium or iridium;
L represents an (R) or (S) chiral diphosphine of formula (I);
H represents a hydrogen atoms and Y represents ClO₄⁻, BF₄⁻ or PF₆⁻.

41. (New) A diphosphino-metal complex comprising an (R) or (S) chiral diphosphine according to claim 30, corresponding to formula (X) below:
M(L)Y₂ (X)
M represents ruthenium, rhodium or iridium;
L represents an (R) or (S) chiral diphosphine of formula (I); and
Y represents an anion such as ClO₄⁻, BF₄⁻ or PF₆⁻.

42. (New) A diphosphino-metal complex comprising an (R) or (S) chiral diphosphine according to claim 30, corresponding to formula (XI) below:
M(L)₂Y (XI)
wherein M represents ruthenium, rhodium or iridium;
L represents an (R) or (S) chiral diphosphine of formula (I); and
Y represents an anion such as ClO₄⁻, BF₄⁻ or PF₆⁻.

43. (New) A for the asymmetric hydrogenation of an unsaturated compound having functional groups corresponding to formula (XXII below: 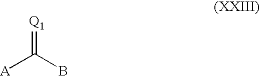
wherein A and B are different and selected from the group consisting of a C₁₋₅ alkyl group, an aryl group, a C₁₋₇ hydroxycarbonyl group, a C₁₋₇ alkoxycarbonyl group, a C₁₋₁₀ aryloxycarbonyl group, a C₁₋₇ halogenoalkyl group, a heteroaryl group, and an optionally saturated cycloalkyl group, said alkyl, aryl and cycloalkyl groups optionally comprising one or more substituents selected from among a halogen, a NO₂ group, a C₁₋₅ alkyl group, a C₁₋₅ alkoxy group, an optionally fused C₁₋₇ cycloalkyl group, an optionally fused aryl group optionally substituted by a halogen, a C₁₋₅ alkyl, a C₁₋₅ alkoxy, said alkyl, cycloalkyl, aryl groups optionally comprising one or more of O, N or Si,
or A and B together form a C₂₋₆ substituted alkyl group, an optionally saturated C₃₋₉ cycloalkyl group, a C₅₋₁₀ aryl group, said groups being optionally substituted by a C₁₋₅ alkyl, a halogen, a hydroxy, a C₅₋₁₀ alkoxy, said groups being optionally substituted by a C₁₋₅ alkyl, a halogen, a hydroxy, a C₁₋₅ alkoxy, an amino such as —NH₂, —NHR₂₀, —N(R₂₀)₂, a sulfino, a sulfonyl, wherein R₂₀ represents an alkyl, an alkoxy or an alkylcarbonyl, said alkyl, cycloalkyl and aryl groups optionally comprising one or more of O, N, S or Si;
Q₁ represents oxygen, a —NR₂₁, —NOR₂₁ or —C(R₂₂)₂ group wherein R₂₁ is a C₁₋₅ alkyl, an aryl group or a heteroaryl group substituted by a C₁₋₄ alkyl, comprising:
treatment of said compound in a solvent in the presence of a diphosphino-metal complex according to any one of claims 4 to 13 as catalyst, at a temperature between 0° C. and 150° C., a hydrogen pressure between 1 and 100 bar, with a quantity of diphosphino-metal complex in relation to a quantity of the unsaturated compound bearing functional groups between 1/50,000 and 1/10.

44. (New) The method according to claim 43, wherein the duration of hydrogenation is greater than or equal to one hour.

45. (New A method for preparation of a compound of formula (I) according to claim 30, comprising:
reacting the compound of formula (XI below: 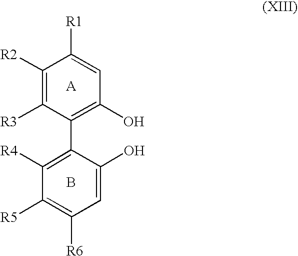
with trifluoromethane sulfonic anhydride to form the compound of formula (XI) below: 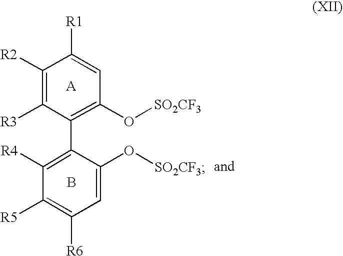
reacting the compound of formula (XII) with a phosphine of formula HP(R₇)(R₈) wherein R₇ and R₈, which can be the same or different, represent an aryl optionally substituted by an alkyl, a halogen or an alkoxy, or represents a C₅₋₆.

46. (New) The method according to claim 45, comprising preparation of the compound of formula (XI) by a coupling reaction of the compound of formula (XV) below: 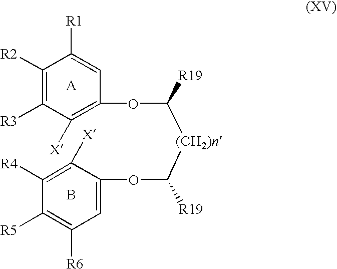
wherein R₁ to R₆ have the same meanings as in formula (XIII), R₁₉ represents an alkyl, methyl, ethyl or an aryl, X′ represents an atom of bromine or iodine and n′ represents a whole number equal to 0, 1, 2, 3 or 4,
to form the diastereoisomerically pure compound of formula (XIV): 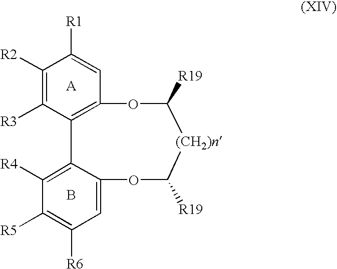
which is then deprotected to form a corresponding biphenol of formula (XIII).

47. (New) The method according to claim 46, comprising preparation of the compound of formula (XV) by a Mitsunobu reaction between the compounds of formula (XVI) and (XVI) below: 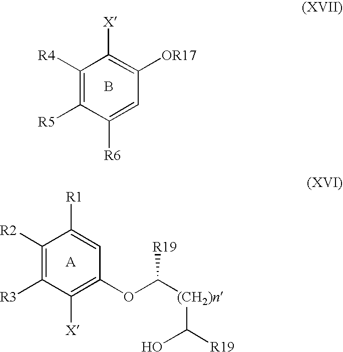
in which R₁ to R₆, R₁₉ and X′ have the same meanings as in formula (XV) and R₁₇ represents an alkyl, aryl or arylalkyl group.

48. (New) The method according to claim 47, comprising preparation of the compound of formula (XVI) by a Mitsunobu reaction from a compound of formula (XVIIIA) below: 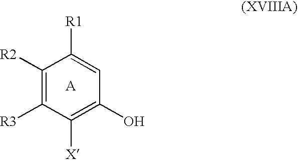
and an optically reactive alkanediol of formula:

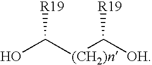

49. (New) The method according to claim 47, comprising preparation of the compound of formula (XVII) from a compound of formula (XVIIIB):

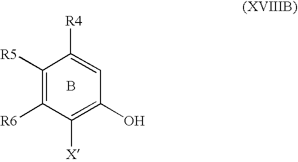

50. (New) The method according to claim 48, comprising preparation of the compound of formula (XVIIIA) from a compound of formula (XIXA): 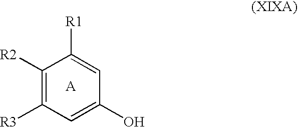
wherein R₁ to R₃ have same the meanings as in formula (XII).

51. (New) The method according to claim 49, comprising preparation of the compound of formula (XVIIIB) from a compound of formula (XIXB): 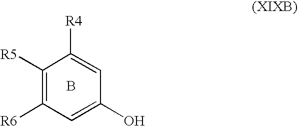
wherein R₄ to R₆ have the same meanings as in formula (XIII).
